(19) United States
(12) Patent Application Publication
(10) Pub. No.: US 2008/0069931 A1
(43) Pub. Date: Mar. 20, 2008

(54) Process for the Preparation of Custard Apple Jam and the Custard Apple Jam thus Obtained

(76) Inventors: Manuswamy Ramanujam Vijayalakshmi, Karnataka (IN); Mysore Najarajurs Shashirekha, Karnataka (IN); Somasundaram Rajarathnam, Karnataka (IN); Revathy Baskaran, Karnataka (IN)

Correspondence Address: KNOBBE MARTENS OLSON & BEAR LLP, 2040 MAIN STREET, FOURTEENTH FLOOR, IRVINE, CA, 92614, US

(21) Appl. No.: 10/550,752

(22) PCT Filed: Mar. 24, 2003
(86) PCT No.: PCT/IN03/00068

§ 371 Date: Sep. 5, 2007

(51) Int. Cl. A23L 1/064; A23B 5/08; A23L 1/222

(52) U.S. Cl. 426/534; 426/541

(57) ABSTRACT

The present invention relates to a process for the preparation of jam from custard apple and the custard apple jam thus obtained, said process comprising the step of (a) mixing a sweetening agent with custard apple juice; (b) partially dehydrating the mixture of step (a) below the temperature of 55° C.; (c) adding additives such as sweetening agent, preservatives, settling agent and other food additives and (d) boiling the mixture of step (c) at a temperature between 90-100° C. and cooling the mixture to obtain the jam.

### TECHNICAL FIELD

The present invention relates to a process for the preparation of Jam from Custard Apple and the custard apple jam thus obtained.

### BACKGROUND ART

Custard apple (Seetaphal) is a tropical fruit grown mainly in the tropical climate. The fruits well known for their delicious taste are heart shaped with light green skin and a soft creamy white flesh. Nutritionally, the fruit is rich in carbohydrate, minerals and excellent source of vitamin C. Besides, high nutritive value, it is known for its excellent medicinal properties. It is said to contain the qualities of the rejuvenating drugs. It has been found to be very useful to the brain and the nervous system. It also enhances muscular strength and tones up the heart.

Processing of custard apple for jam is rendered inaccessible due to its characteristic property of discoloration, development of bitterness and off-flavor, wherein the fruit pulp is heated above 55° C. The fresh fruit pulp contains ˜75% water along with TSS of ˜25° B, enriched by reducing sugars. During the normal course of preparation of any fruit jam, it is required to boil the fruit pulp along with the addition of sugar, acid, preservative(s) and solubilized pectin, to adjust the ultimum TSS to 68° B. By boiling the custard apple fruit pulp, the above mentioned 3 characteristic problems are imminent and unavoidable. So far no processed product as jam of custard apple is available in the market.

### SUMMARY OF THE INVENTION

The present invention entails to describe a process to prepare jam from custard apple fruits, overcoming the three characteristic problems of discoloration, development of bitterness and off-flavor and also the custard apple jam thus obtained.

### OBJECTS OF TH INVENTION

The main objective of the present invention is to provide a process for the preparation of jam from custard apple pulp.

Another objective of the present invention is to avert the problem of discoloration, development of bitterness and off-flavor, characteristic of custard apple pulp, when heated beyond 55° C.

Yet another objective of the present invention is to achieve effective storage life of the processed product at room temperature.

In a further objective of the present invention the partially dehydrated pulp sugar mixture in required proportions may be used for the preparation of jam of 68° B.

In a still further objective of the present invention the custard apple jam comprises custard apple pulp along with adequate quantity of a sweetening agent, a setting agent, a flavoring agent and a food preservative for a shorter period.

### DETAILED DESCRIPTION OF THE INVENTION

Accordingly, the present invention provides a process for preparing a custard apple jam without discoloration, bitterness and off-flavor, said process comprising the steps of (a) mixing a sweetening agent with custard apple pulp; (b) partially dehydrating the mixture of step (a) below the temperature of 55° C.; (c) adding additives such as sweetening agent, preservatives, settling agent and other food additives; and (d) boiling the mixture of step (c) at a temperature between 90-100° C. and cooling the mixture to obtain the jam.

The novelty of the present invention lies in the partial dehydration of a mixture comprising custard apple pulp and sweetening agent at a temperature less than 55° C. to obtain 40% to 60% residual moisture. Custard apple pulp after partial dehydration at a temperature less than 55° C. under vacuum, requires mixing with a pre-heated solution containing pectin, sugar and citric acid, at 95-98° C. to a final ° B of 68 to 70, followed by setting at room temperature. This serves to overcome the three problems, discoloration, development of bitterness and off-flavor, very characteristic of the custard apple pulp, when processed in the routine course of preparing a fruit jam. The Inventors have found that the step of partially dehydrating the mixture of custard apple pulp and the sweetening agent by heating the mixture essentially below a temperature of 55° C. and under reduced pressure is very critical to the nature of the jam thus obtained. The Inventors have found during innumerous experiments conducted that if the custard apple pulp is not dehydrated, the shelf life of the custard apple jam is not high. Further, the Inventors have found that even if the custard apple pulp is partially dehydrated at temperatures above 55° C., the custard apple jam thus prepared develops a bitter taste and hence, is not suitable for consumption. Also, the residual moisture content in the mixture of custard apple pulp and sugar is very critical to the acceptance of the jam thus obtained. If the partial dehydration of the mixture removes excess of moisture from the mixture, the jam thus obtained develops off-flavor. On the other hand, if partial dehydration is not done to remove sufficient quantity of the moisture, it affects the shelf life of the product thus obtained. Thus, the Inventors have arrived at the particular sequence of steps after much experimentation and the same should not be considered to be obvious to a ordinary person skilled in the art.

Accordingly, the product prepared is pleasant flavored, storable, and eventually represents the value added form of the custard apple fruit, that aids to conserve the excess fruit production and fast perishable ripe fruits, to cater to the needs of the populations during off-season and in areas bereft of custard apple production, ultimately targeting at good economic returns.

The process of the present invention more particularly involves the following steps (a) obtaining the custard apple pulp; (b) mixing the custard apple pulp of step (a) with a sweetening agent in the ratio of 1:0.5 to 1:1 to obtain a pulp mixture; (c) partially dehydrating the pulp mixture of step (b) under vacuum below a temperature of 55° C. to obtain a partially dehydrated pulp mixture; (d) adding a preheated syrup containing a sweetening agent, a setting agent and a flavoring agent to the partially dehydrated pulp mixture of step (c); (e) boiling the mixture of step (d) till the total soluble solids reaches to 68° B to 70° B; (f) allowing the mixture of step (e) to cool to the room temperature, and (g) adding permitted food preservatives to the range of 50 ppm to 250 ppm to obtain the custard apple jam.

In an embodiment of the present invention, it was required to overcome the problems of discoloration, development of bitterness and off-flavor, while processing of pulp.

In another embodiment, the low pectin pulp was amended to obtain the jam consistency.

In another embodiment, the pulp along with sugar may be subjected to vacuum concentration by using a vacuum shelf drier at the temperature of 50-55° C. with system pressure of 0.2-0.8 kg cm⁻².

In a further embodiment of the present invention, the custard apple pulp is obtained from fresh ripe custard apple fruits.

In another embodiment, the custard apple pulp is obtained by scooping the pulp from ripe fruits using a pulper followed by separating the seeds from the same.

In yet another embodiment, the sweetening agent used is sugar.

In a further embodiment, the pulp mixture is partially dehydrated under vacuum of 0.2 to 0.8 Kgcm⁻².

In yet another embodiment, the pulp mixture is partially dehydrated to remove 40 to 60% moisture content.

In a further embodiment, the setting agent used is pectin and the flavoring agent used is citric acid.

In a still further embodiment, the partially dehydrated pulp is mixed with 10 to 30% by wt. of sugar, 0.7 to 1.0% by wt. of pectin and 0.4 to 0.55% by wt. of citric acid.

In yet another embodiment, the mixture is boiled at a temperature ranging between 95° C. to 98° C.

In another embodiment of the present invention, the permitted food preservative is sodium benzoate.

In a still further embodiment, the jam thus obtained comprises custard apple pulp along with adequate quantity of a sweetening agent, a setting agent, a flavoring agent and a food preservative.

In yet another embodiment of the present invention, the custard apple jam thus obtained contains 35-55% by wt. of custard apple pulp, 45 to 60% by wt. of a sweetening agent, 0.5 to 1.5% by wt. of a setting agent, 0.25 to 1.0% by wt. of a flavoring agent and 0.01 to 0.05% by wt. of a food preservative.

In yet another embodiment of the present invention, the jam is shelf stable at ambient temperature for a period of not less than 6 months.

The following examples are given by way of illustration of the present invention and its use for preparation of jam, and therefore should not be construed to limit the scope of the present invention.

### EXAMPLE 1

450 g of custard apple pulp extracted from custard apple fruits collected from sub-tropical climate, where the pulp had 25.5° B, 0.16% acidity, 5.87 pH, 1.07% pectin and 6.7% alcohol insolubles was mixed with 300 g of sugar. The mixture with an initial brix 48° B was heated below 55° C. under vacuum (0.2 kg cm⁻²), to reduce the water content by 60%. So partially dehydrated pulp was added to the separately boiled solution containing 268 g of sugar, 8 g of pectin (4% solution) and 4.3 g citric acid. Boiling continued till the mixture attained a 68° brix with continuos stirring. With the addition 236 mg of sodium benzoate dissolved in a little warm water, the product was filled hot into pre sterilized glass bottled, screw capped wiped and labeled. The process resulted in jam with pleasant custard apple flavor.

### EXAMPLE 2

450 g of custard apple pulp extracted from custard apple fruits were collected from hilly, low temperature region, where the pulp contained 23.3° B, 0.31% acidity, 4.70 pH, 1% pectin and 3.56% alcohol insolubles was mixed with 300 g of sugar. The mixture with an initial brix 48° B as heated below 55° C. under vacuum (0.2 kg cm⁻²), to reduce the water content by 60%. So partially dehydrated pulp was added to the separately boiled solution containing 276 g of sugar, 8 g of pectin (4% solution) and 3.6 g citric acid. Boiling continued till the mixture attained a 68° brix with continues stirring. With the addition 236 mg of sodium benzoate dissolved in a little warm water, the product was filled hot into pre sterilized glass bottled, screw capped wiped and labeled. The process resulted in jam with pleasant custard apple flavor.

### EXAMPLE 3

450 g of custard apple pulp extracted from custard apple fruits were collected from tropical belt, where the pulp had 25.3° B, 0.26% acidity, 4.93 pH, 1.53% pectin and 4.70% alcohol insolubles was mixed with 300 g of sugar. The mixture with an initial brix 48° B as heated below 55° C. under vacuum (0.2 kg cm⁻²), to reduce the water content by 60%. So partially dehydrated pulp was added to the separately boiled solution containing 268 g of sugar, 8 g of pectin (4% solution) and 5 g citric acid. Boiling continued till the mixture attained a 68° brix with continuos stirring. With the addition 236 mg of sodium benzoate dissolved in a little warm water, the product was filled hot into pre sterilized glass bottles, screw capped wiped and labeled. The process resulted in jam with pleasant custard apple flavor.

In all the three cases, the fresh pulp responded similarly to obtain jam, that was free of discoloration, development of bitterness and off-flavor. The product has pleasant flavor.

The main advantages of the present invention are:
a) The invention describes for the first time a process for the preparation of jam without the problems of discoloration, development of bitterness and off-flavor, characteristic of custard apple when heated to a temperature above 55° C.
b) The jam prepared represents the value added form of custard apple, of extended storage, to offer to the needs off-season, since the fruit setting/availability is sharp seasoned.
c) The process employed is quite simple yet, it is unobvious and the outcome is surprising since the product retained as far as possible, the original (fresh) properties.
d) The product can be transferred to distant places, for easier export for considerable economic gains.
e) Preparation of jam from custard apple encourages the growers to produce more of the fruit that requires little agronomic care.

1. A process for preparing a custard apple jam having higher shelf life and without discoloration, bitterness, and off-flavor, said process comprising steps of
(a) mixing a sweetening agent with custard apple pulp;
(b) partially dehydrating the mixture of step (a) below the temperature of 55° C.;
(c) adding additives such as sweetening agent, preservatives, settling agent and other food additives; and
(d) boiling the mixture of step (c) at a temperature between 90-1 00° C. and cooling the mixture to obtain the jam.

2. A process as claimed in claim 1, said process comprising the steps of:
(a) obtaining the custard apple pulp;
(b) mixing the custard apple pulp of step (a) with a sweetening agent in the ratio of 1:0.5 to 1:1 to obtain a pulp mixture;
(c) partially dehydrating the pulp mixture of step (b) under vacuum below a temperature of 55° C. to obtain a partially dehydrated pulp mixture;
(d) adding a preheated syrup containing a sweetening agent, a setting agent and a flavoring agent to the partially dehydrated pulp mixture of step (c);
(e) boiling the mixture of step (d) till the total soluble solids reaches to 68° B to 70° B;
(f) allowing the mixture of step (e) to cool to the room temperature, and
(g) adding permitted food preservatives to tile range of 50 ppm to 250 ppm to obtain the custard apple jam:

3. A process as claimed in claim 2 wherein in step (a), the custard apple pulp is obtained from fresh ripe custard apple fruits.

4. A process as claimed in claim 2 wherein in step (a), the custard apple pulp is obtained by scooping the pulp from ripe fruits using a pulper followed by separating the seeds from the same.

5. A process as claimed in claim 2 wherein in step (b), the sweetening agent used is sugar.

6. A process as claimed in claim 2 wherein in step (c), the pulp mixture is partially dehydrated under vacuum of 0.2 to 0.8 Kgcm ⁻².

7. A process as claimed in claim 2 wherein in step (c), the pulp mixture is partially dehydrated to remove 40 to 60% moisture content.

8. A process as claimed in claim 2 wherein in step (d), the sweetening agent used is sugar.

9. A process as claimed in claim 2 wherein in step (d), tile setting agent used is pectin.

10. A process as claimed in claim 2 wherein in step (d) the flavoring agent used is citric acid.

11. A process as claimed in claim 2 wherein in step (d)′ tile partially dehydrated pulp is mixed with 10 to 30% by wt. of sugar, 0.7 to 1.0% by wt. of pectin and 0.4 to 0.55% by wt. of citric acid.

10. (cancelled)

11. (cancelled)

12. A process as claimed in claim 2 wherein in step (c), the mixture is boiled at a temperature ranging between 95° C. to 98° C.

13. A process as claimed in claim 2 wherein in step (g), the permitted food preservative is sodium benzoate.

14. A custard apple jam having higher shelf life and without discoloration, bitterness, and off-flavor obtained by the process as claimed in claim 1, wherein said jam comprises custard apple pulp along with adequate quantity of a sweetening agent, a settling agent, a flavoring agent and a food preservative.

15. A custard apple jam having higher shelf life and without discoloration, bitterness, and off-flavor obtained by the process as claimed in claim 1, wherein said jam contains 35-55% by wt. of custard apple pulp, 45 to 60% by wt. of a sweetening agent, 0.5 to 1.5% by weight of a settling agent, 0.25 to 1.0% by wt. of a flavoring agent and 0.01 to 0.05% by wt. of a food preservative.

16. A custard apple jam having higher shelf life and without discoloration, bitterness, and off-flavor obtained by the process as claimed in claim 1, wherein said jam is shelf stable at ambient temperature for a period of not less than 6 months.

17. A custard apple jam having higher shelf life and without discoloration, bitterness, and off-flavor obtained by the process as claimed in claim 1, wherein the sweetening agent is sugar.

18. A custard apple jam having higher shelf life and without discoloration, bitterness, and off-flavor obtained by the process as claimed in claim 1, wherein the settling agent is pectin.

19. A custard apple jam having higher shelf life and without discoloration, bitterness, and off-flavor obtained by the process as claimed in claim 1, wherein the flavoring agent is citric acid.

20. A custard apple jam having higher shelf life and without discoloration, bitterness, and off-flavor obtained by the process as claimed in claim 1, wherein the food preservative is sodium benzoate.
